(19) United States
(12) Patent Application Publication
(10) Pub. No.: US 2005/0263382 A1
(43) Pub. Date: Dec. 1, 2005

(54) Chain pull switch indicia for ceiling fans

(76) Inventor: Richard C. Desmond, Hamburg, NY (US)

Correspondence Address: KAPLAN GILMAN GIBSON & DERNIER L.L.P., 900 ROUTE 9 NORTH, WOODBRIDGE, NJ, 07095, US

(21) Appl. No.: 11/121,431

(22) Filed: May 4, 2005

Related U.S. Application Data
(60) Provisional application No. 60/575,050, filed on May 27, 2004.

(51) Int. Cl. H01H 3/20

(52) U.S. Cl. 200/331

(57) ABSTRACT

Indicia for identifying pull switches for ceiling fans are provided, i.e., an indicia such as but not limited to an ornamental figurine indicating light or heat for the pull chain for the light switch and an ornamental figurine indicating wind, air or a fan for the pull switch for the fan. By associating indicia such as a figurine, text or the like with each function the need to pull each chain to find out if it's the right one is eliminated.

### CROSS REFERENCE TO RELATED APPLICATIONS

This application claims the benefits of U.S. Provisional Patent Application No. 60/575,050, filed May 27, 2004, entitled “Chain Pull Switch Indicia For Ceiling Fans,” the entire disclosure of which is hereby incorporated by reference.

### BACKGROUND OF THE INVENTION

This invention relates to ceiling fan chain pull switches and in particular, to indicia for chain pull switches delineating a chain pull switch for a light and a chain pull switch for a fan.

Ceiling fans are often equipped with more than one chain pull switch, at least one for a light fixture associated with the ceiling fan and at least one chain pull switch for the fan. It is often difficult to know which chain pull switch operates which device, hence, only through the trial and error process of pulling each chain can one determine the appropriate chain to pull to achieve the desired result, i.e., turning on the fan or turning on the light. Such a process is tedious and results in excessive wear on the pull switches, and the motor of the fan and in shortened life of the light source, typically at least one light bulb.

Accordingly, there is a need for a device to eliminate the confusion associated with differentiating between the two pull chain switches on most ceiling fans.

### SUMMARY OF THE INVENTION

The present invention associates indicia such as but not limited to a figurine for each of the chain pull switches, i.e., an indicia such as but not limited to an ornamental figurine indicating light or heat for the pull chain for the light switch and an ornamental figurine indicating wind, air or a fan for the pull switch for the fan. By associating indicia such as a figurine, text or the like with each function the need to pull each chain to find out if it's the right one is eliminated. In addition, the indicia can be made so as to be readily recognizable in the dark merely by touch. For example, the fan indicia can be made in the form of a fan that is readily recognizable in the dark as being for the fan. The light switch indicia can be made in the form of a sun that is easily recognizable simply by touch. This embodiment is especially useful in situations such as where a user wishes to turn on a fan on a hot night (or turn it off or adjust the speed when it becomes too cool) without turning on the light accidentally, disturbing persons sleeping in the room.

Preferably indicia extend from the end of the appropriate pull switch distal the ceiling fan, i.e., the end typically grasped by a user. Optionally the indicia may be placed anywhere along the length of the chain, or on the ceiling fanlight device at the location the appropriate pull switch enters the device. In a preferred embodiment the indicia of the present invention comprises a chain extending therefrom suitable for attachment to an existing chain of a ceiling fan.

Indicia in the form of figurines with blades, propellers and the like or associated with moving air such as but not limited to blowing wind, tornadoes and the like etc. are preferred embodiments of indicia usable to represent the fan switch. Indicia in the form of figurines with light bulb(s), flame(s), lamp(s), the sun, star(s) or the like or any indicia associated with light or brightness etc. are preferred embodiments of the indicia employed to represent the light switch.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIGS. 1A-1D depict embodiments of indicia in accordance with at least one aspect of the present invention.

FIGS. 2A-2D depict embodiments of indicia in accordance with at least one aspect of the present invention.

FIG. 3 depicts an embodiment in accordance with at least one aspect of the present invention.

FIG. 4 depicts an embodiment in accordance with at least one aspect of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment.

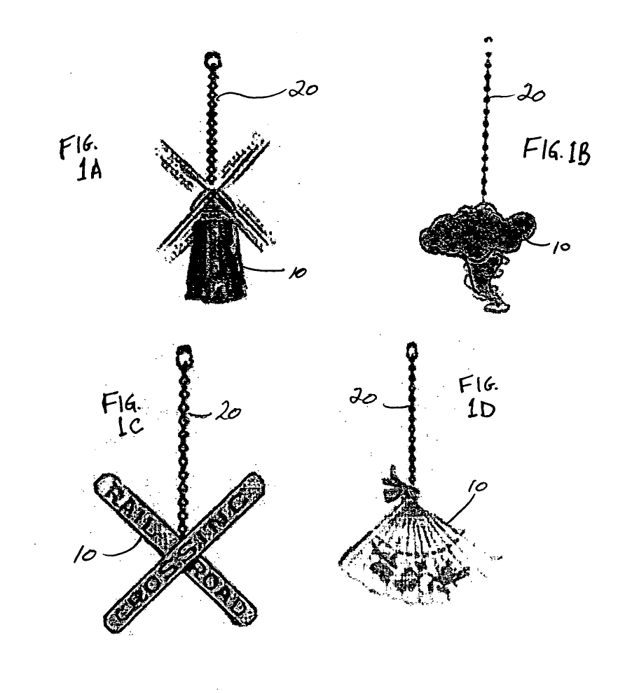

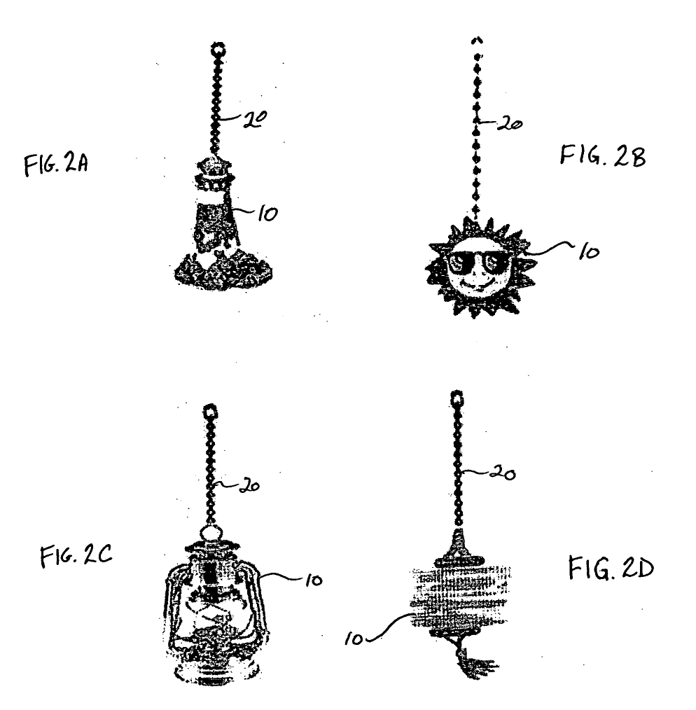

Now referring to FIGS. 1A-2D in accordance with at least one aspect of the present invention an indicia element 10 is disclosed for association with a pull switch 20 of a ceiling fan.

Now referring to FIGS. 1A-1D, indicia element 10 may comprise indicia in the form of figurines, wording, letter(s), color(s) or the like. For example, indicia element 10 may comprise a figurine or the like with blades, propellers and the like or associated with moving air such as but not limited to blowing wind, tornadoes and the like usable to represent a fan switch. Alternatively, indicia element 10 may comprise a word such as but not limited to “FAN”, “COOL” or the like to represent a fan pull cord. Alternatively, letters such as but not limited to “F′” (indicating “fan”), “C” (indicating “cool”) and the like may be employed as indicia element 10 to indicate a fan pull cord. Alternatively, a color such as but not limited to the color blue may be employed as indicia element 10 to indicate a fan pull cord.

Now referring to FIGS. 2A-2D, indicia element 10 may comprise indicia in the form of figurines, wording, letter(s), color(s) or the like. For example, indicia element 10 may comprise a figurine or the like with light bulb(s), flame(s), lamp(s), the sun, star(s) or the like or any indicia associated with light or brightness and the like usable to represent a light switch. Alternatively, indicia element 10 may comprise a word such as but not limited to “LIGHT”, “HOT” or the like to represent a light pull cord. Alternatively, letters such as but not limited to “L′” (indicating “light”), “H” (indicating “hot”) and the like may be employed as indicia element 10 to indicate a light pull cord. Alternatively, a color such as but not limited to the color red may be employed as indicia element 10 to indicate a light pull cord.

Indicia element 10 is employed to differentiate between the cord or chain 20 associated with a light member 30 and fan member 40 of a ceiling fan 50. It will be apparent to one skilled in the art that only one indicia is required in order to differentiate between a light member and fan member of a ceiling fan. That is, if a ceiling fan having two pull switches, one for a light and one for a fan, is equipped with indicia element 10 identifying one or the other, while it may be desirable to have further indicia element 10 to identify the other switch, it is not required.

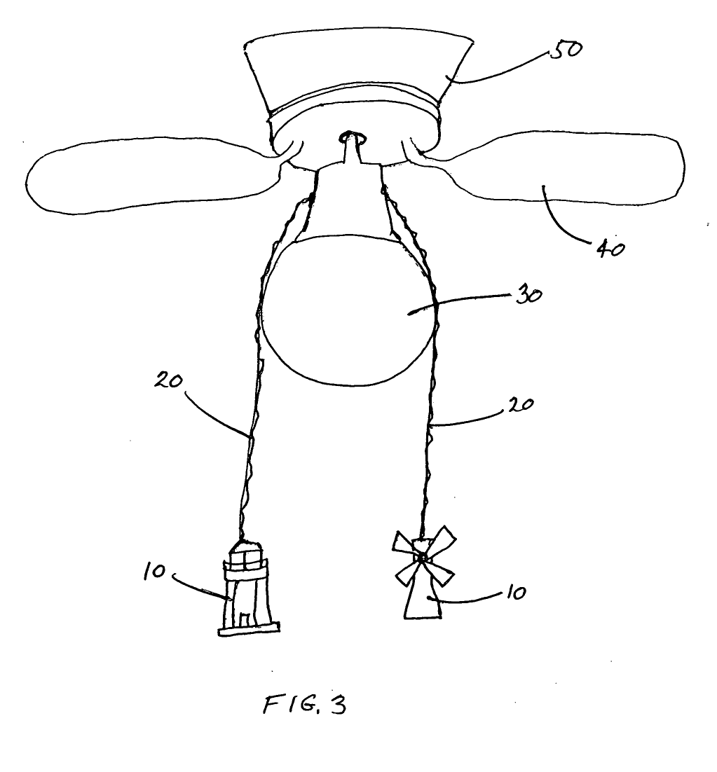

Now referring to FIG. 3, in a preferred embodiment indicia element 10 extends from an end of a pull cord 20 adapted to function with a ceiling fan 50. In yet another embodiment a ceiling fan 50 having a fan member 40 and a light member 30 is provided with at least one pull cord 20, said pull cord having at least one indicia element 10 adapted to indicate the member with which it is associated, i.e., the light member 30 or the fan member 40.

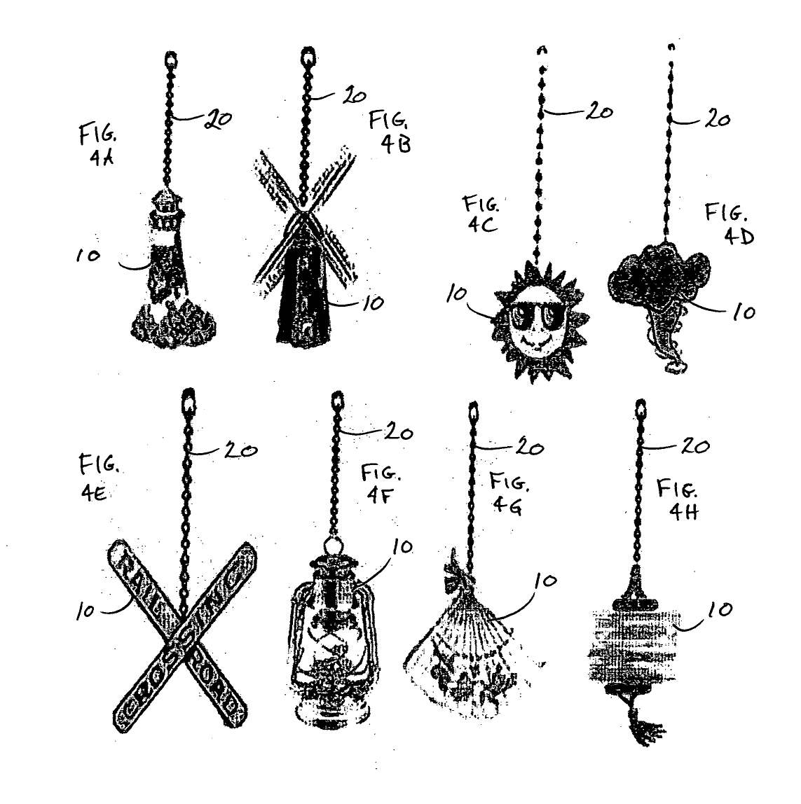

Now referring to FIGS. 4A-H, in a preferred embodiment, indicia 10 are employed to depict different themes in which one indicia element 10, representing air, wind or a fan-like structure or the like, denotes the pull switch 20 associated with the fan, and the other indicia element 10, representing light, brightness or heat, denotes the pull switch 20 for the light. For example, FIGS. 4A-4B depict a manmade structure theme. FIGS. 4C-4D depict a natural elements theme. FIGS. 4E-4F depict a railroad theme. FIGS. 4G-4H depict a Japanese theme. It will be apparent to those skilled in the art many other themes can be employed.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. Indicia for a pull switch, said indicia comprising information sufficient to identify the function of at least one pull switch.

2. The invention according to claim 1 said indicia comprising information sufficient to identify the function of a pull switch as operable with either a fan or a light.

3. The invention according to claim 1 said indicia comprising at least one letter.

4. The invention according to claim 1 said indicia comprising at least one figurine.

5. The invention according to claim 1 said indicia comprising at least one color.

6. The invention according to claim 1 said indicia comprising at least one word.

7. The invention according to claim 1 said indicia extending from a pull switch.

8. The invention according to claim 1 said indicia extending from an end of a pull switch.

9. The invention according to claim 1 said indicia employed in association with a ceiling fan apparatus.

10. The invention according to claim 1 said indicia employed in association with a ceiling fan apparatus having more than one pull switch.

11. The invention according to claim 10 comprising at least one indicia for each pull switch.

12. The invention according to claim 11, at least one indicia comprising information sufficient to identify a light switch.

13. The invention according to claim 11, at least one indicia comprising information sufficient to identify a fan switch.

14. The invention according to claim 10 comprising indicia for identifying a fan switch and indicia for identifying a light switch.

15. The invention according to claim 14, said employed for said fan and said light switch having a common theme.

16. A ceiling fan pull switch having at least one indicia extending therefrom, said indicia comprising information sufficient to identify a function of said pull switch.

17. A ceiling fan assembly comprising at least one pull switch and at least one indicia associated with said pull switch comprising information sufficient to identify a function of said pull switch.
